(19) United States
(12) Patent Application Publication
(10) Pub. No.: US 2009/0257336 A1
(43) Pub. Date: Oct. 15, 2009

(54) Device for marking optical discs in a non-destructive, tamper-proof manner for licensing and other purposes

(76) Inventors: Anthony David Knight, San Jose, CA (US); Jonny Boyd Reckless, San Francisco, CA (US)

Correspondence Address: PATENT DEPARTMENT;MACROVISION CORPORATION, 2830 DE LA CRUZ BLVD., SANTA CLARA, CA, 95050, US

(21) Appl. No.: 12/316,409

(22) Filed: Dec. 12, 2008

Related U.S. Application Data
(63) Continuation-in-part of application No. 12/082,123, filed on Apr. 9, 2008.

(51) Int. Cl. G11B 9/00; G11B 17/03; G11B 7/24

(52) U.S. Cl. 369/99; 720/703; 720/718; G9B/17.009; G9B/9

(57) ABSTRACT

A marking device for marking optical discs in a non-destructive, tamper-proof manner for licensing and other purposes such as part of a digital content library service includes top and bottom structures coupled together by a hinge. The bottom structure is adapted with a mounting post in a recessed area defined by opposing curved ledges to hold an optical disc for marking. The top structure is adapted with a removable tool having an embossed symbol for impressing a mark on the held optical disc by applying pressure to the top structure when the device is in a closed position. The top structure is also adapted with perforations for alternatively or additionally injecting a permanent ink onto the optical disc so that a mark defined by the pattern of perforations may be placed on the optical disc.

### CROSS REFERENCE TO RELATED APPLICATIONS

This application is a continuation-in-part to U.S. application Ser. No. 12/082,123 filed Apr. 9, 2008, which is incorporated herein by reference.

### FIELD OF THE INVENTION

The present invention generally relates to the permanent marking of optical media and in particular, to a device for marking optical discs in a non-destructive, tamper-proof manner for licensing and other purposes such as part of a digital content library service.

### BACKGROUND

Optical discs are widely used for distributing digital content such as music on compact discs (“CDs”) and movies on digital versatile discs (“DVDs”). As consumers expand their libraries of digital content on optical discs, however, the libraries become increasingly more cumbersome to use and keep track of.

Storage of digital content on random access memories such as hard disks for playback on personal computers (“PCs”) and flash memories for playback on portable media players (“PMPs”) overcomes many physical problems encountered with large libraries of optical discs. Additional benefits of random access memories include easier searching for and faster access to desired content for playback. Further, enhanced search capability, similar in usage to standard internet searching, may be possible with related metadata stored in addition to the digital content.

Although consumers are allowed to copy music purchased on CDs to their PCs and from their PCs to their PMPs, they are not allowed the same freedom to copy movies distributed on DVDs. Legal ripping solutions for DVD movies have been proposed, but there has been resistance to any notion of a secure managed copy, with some rights holders taking the position that content is forever married to the plastic it is shipped on. Some view attempts to copy content protected by the Content Scramble System (“CSS”) as either a violation of the Digital Millennium Copyright Act or a breach of applicable license agreements or the CSS Procedural Specifications.

### SUMMARY

Accordingly, it is an object of one or more aspects of the present invention to provide a digital content library service in which a one-to-one relationship may be enforced between a protected tangible medium and a corresponding protected electronic file provided as part of the digital content library service.

Another object of one or more aspects of the present invention is to provide a device for marking optical discs in a non-destructive, tamper-proof manner for licensing and other purposes such as part of a digital content library service.

These and additional objects are accomplished by the various aspects of the present invention, wherein briefly stated, one aspect is an apparatus for marking an optical disc, comprising: a first structure; a second structure having a marker; and a hinge coupling the first structure to the second structure so that the marker is adapted to mark an optical disc when the optical disc is being held by the first structure and the second structure is pivoted towards the first structure.

Another aspect is a method for marking an optical disc comprising: marking an optical disc by pivoting a marker about a hinge so as to press the marker against an area between an inner radius and a lead-in on a playing surface of the optical disc.

Another aspect is a method for marking an optical disc, comprising: selecting a first marker having a first symbol from a plurality of markers having different symbols; coupling the first marker to a top structure; inserting a first optical disc into a recessed area of a base structure and mounting the first optical disc onto a chamfered post of the base structure so that the first optical disc is held by the base structure; and pivoting the top structure about a hinge coupling the top structure to the base structure so as to impress the first symbol onto the first optical disc. In a manner that is not removable without damaging the first optical disc and does not interfere with the playing of content stored on the first optical disc.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 illustrates a block diagram of a system for providing a digital content library service utilizing aspects of the present invention.

FIG. 2 illustrates a flow diagram of a method for generating a list of DVDs as part of a digital content library service utilizing aspects of the present invention.

FIG. 3 illustrates a flow diagram of a method for processing a list of DVDs as part of a digital content library service utilizing aspects of the present invention.

FIG. 4 illustrates a display screen showing a user's library as part of a digital content library service utilizing aspects of the present invention.

FIG. 5 illustrates a display screen showing movie information and viewing options as part of a digital content library service utilizing aspects of the present invention.

FIG. 6 illustrates a flow diagram of a method for processing a customer's retail purchase as part of a digital content library service utilizing aspects of the present invention.

FIG. 7 illustrates a perspective view of a device for marking optical discs utilizing aspects of the present invention.

FIG. 8 illustrates a side view of a device for marking optical discs utilizing aspects of the present invention.

FIG. 9 illustrates a bottom view of an optical disc to be marked by a device for marking optical discs utilizing aspects of the present invention.

### DETAILED DESCRIPTION

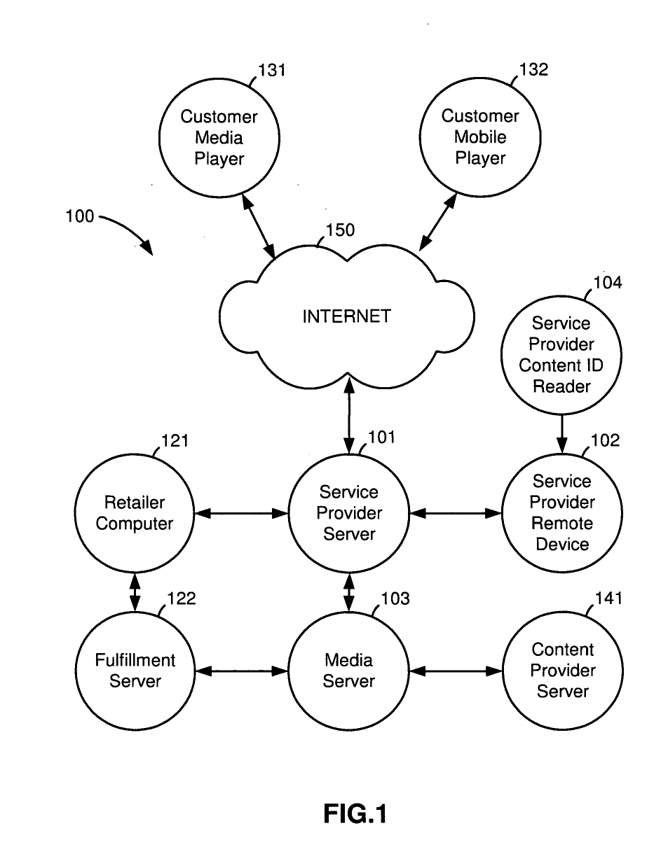

FIG. 1 illustrates a block diagram of a system 100 in which a service provider provides a digital content library service to its subscribers (also referred to as “customers”) using a server 101 which interacts with a number of other computers and devices as shown. The library service allows copies of digital content listed as being available for transfer in a customer's account to be made available to the customer for transferring (e.g., downloading by the customer) to a hard disk drive of a digital media player operated by the customer (such as customer media player 131) for a fee. The library service also allows digital content that has already been downloaded to the digital media player (i.e., the customer's library with the service) to be made available for playing on a portable media player operated by the customer (such as customer mobile player 132) for another fee, provided such usage right is permitted by the content owner through a business arrangement with the service provider (such as receiving a percentage of the fee charged by the service provider).

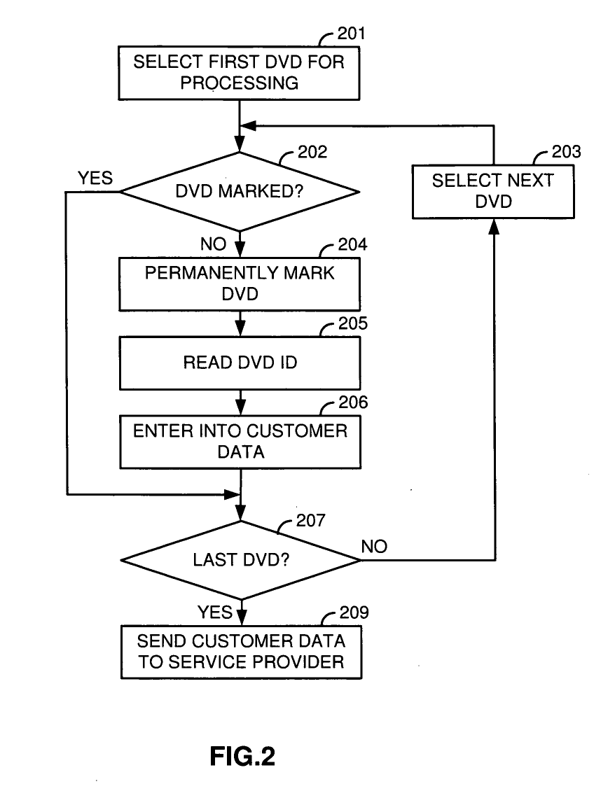

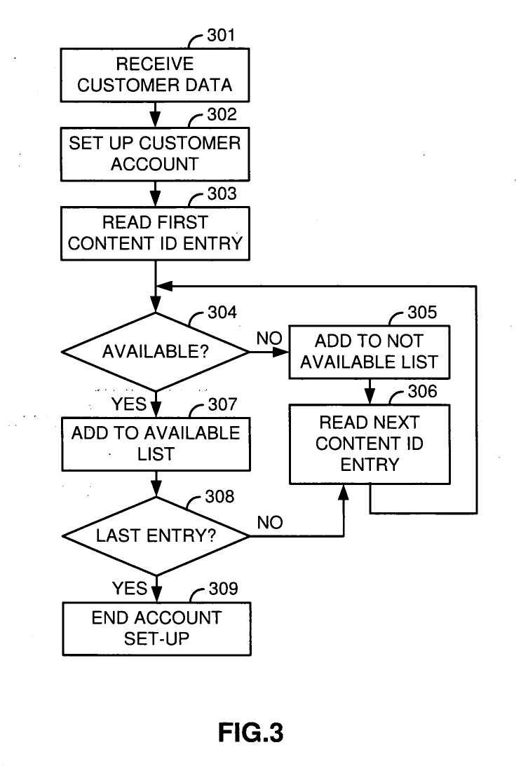

Each subscriber's account may be established and/or updated with the library service in a number of ways. For example, if the subscriber desires to have digital content from DVDs in the subscriber's possession included in the subscriber's account with the library service, then an agent (i.e., employee or contractor) for the service provider may come out to the subscriber's residence (or other convenient location) and transmit information of the subscriber and the subscriber's DVD library to the service provider server 101 using a remote communication device 102 according to the method described in reference to FIG. 2. Upon receiving the information, the service provider server 101 then creates and/or enters the received information into the subscriber's account according to the method described in reference to FIG. 3.

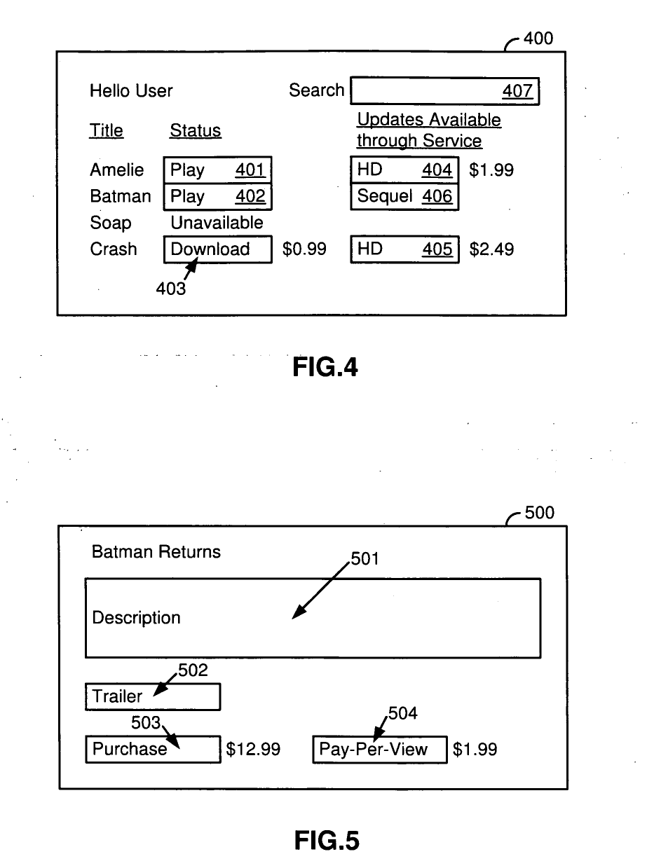

As another example, if the subscriber purchases (i.e., licenses) a copy of digital content directly from the service provider server 101 while logged-on his or her account, then a digital content identifier uniquely associated with the purchased content is entered directly into the subscriber's account. The digital content in this case may have been offered as an update (e.g., updated format or a sequel) to digital content already included in the customer's digital content library or it may have been offered as a result of a search query performed by the customer as described in reference to FIG. 4. Alternatively, the customer may have agreed at some time to automatically purchase the update when it becomes available. In that case, of course, the subscriber does not have to be logged-on in order to purchase update. The digital content may also have been offered as a result of the customer's viewing (or listening) habits or an interests survey completed by the customer at some time such as when first registering with the library service.

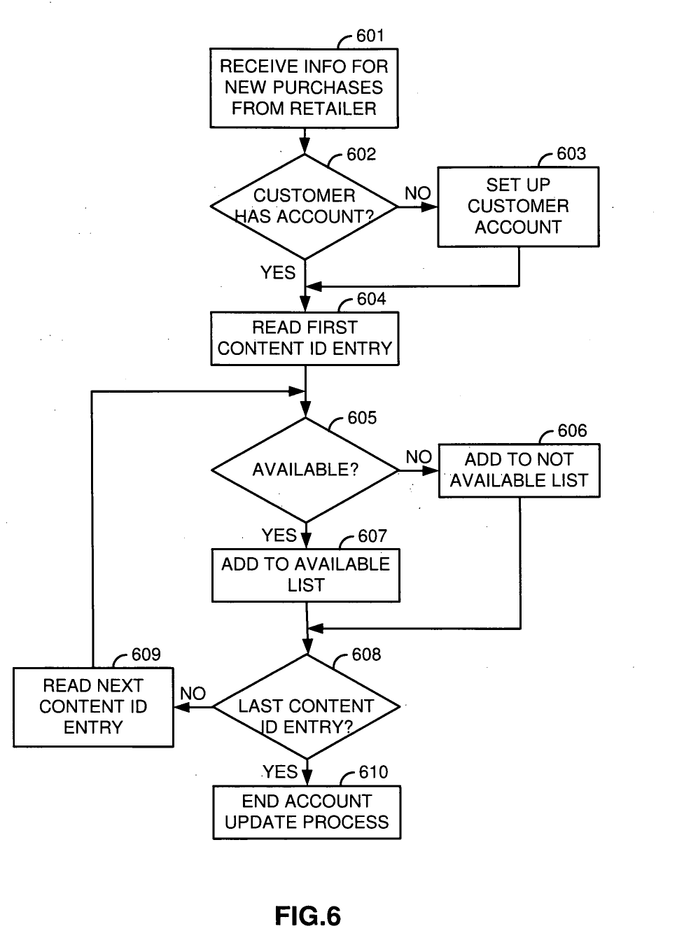

As yet another example, if the subscriber desires to have DVDs that the subscriber is purchasing at the time from a retailer included in the subscriber's account with the library service, then an employee of the retailer transmits information of the subscriber along with digital content identifications for each DVD purchased to the service provider server 101 using a retailer computer 121 according to the method described in reference to FIG. 6. Also, if the subscriber prefers to bring his or her previously purchased DVDs to the retailer to have them included in the subscriber's account with the library service, he or she may bring them to the retailer for such entry rather than having an agent come to the subscriber's residence to do so as previously described.

In order to make digital content available for transferring, the service provider, first negotiates license agreements with content providers of the digital content and downloads or otherwise receives master copies of the licensed digital content from content provider servers operated by or for the content providers (such as content provider server 141). Transmission of the licensed digital content may occur over a direct line as shown in FIG. 1 or over the Internet 150 using conventional public-private key encryption or other secure transmission techniques.

A key component of the digital content library service is the customer's digital media player 131 which not only communicates with the service provider's server 101 over the Internet 150 to download, store, and play copies of digital content in the consumer's digital content library, but also ensures that the downloaded content is not illegally copied or otherwise transferred or made available to other devices. Thus, a prerequisite to participating in the digital content library service is for the consumer to first purchase from a retailer a digital media player that is compatible with the service. In order to interact with the digital media player, an input device such as keyboard and/or a pointing device is provided along with and coupled to the player as well as a means to access the Internet if not already available.

Before the retailer delivers the home player to a customer, however, an agent of the service provider first generates information for the customer's list of DVDs which is transmitted to the service provider server 101 as part of the digital content library service. The agent may be an employee or contractor of the service provider, or an employee or contractor of a retailer that has sold the digital media player to the customer. Although DVDs are used in the examples described herein to illustrate various aspects of the present invention, it is to be appreciated that the present invention is not to be limited as such and includes all tangible media as that term is understood to mean under copyright laws, examples of which include optical media, tape, flash memory, and the like.

FIG. 2 illustrates a flow diagram of a method performed by the agent of the service provider for generating information to be transmitted to the service provider server 101 (of FIG. 1) for the customer's DVDs.

In a step 201, the service provider's agent selects a first DVD from the customer's collection for processing. In a step 202, the agent determines whether or not it is okay to provide a copy of the digital content on the DVD as part of the digital content library service by visually inspecting the DVD (and/or its cover) to determine whether it has been permanently marked in a prescribed manner, such as scoring the disc near the center ring, scoring the cover with a particular pattern at a particular location, or marking the disc or cover using permanent ink with a particular pattern at a particular location.

If the DVD has been permanently marked in the prescribed manner, then the determination in the step 202 is a YES. In this case, the agent rejects the current DVD for further processing and proceeds to a step 207 for further processing as described in detail below. On the other hand, if the DVD has not been permanently marked in the prescribed manner, then the determination in the step 202 is a NO. In this latter case, the method proceeds to a step 204 where the agent permanently marks the DVD in the prescribed manner, for example, using a scoring device, similar to a one-hole punch, to score the disk near the center ring, so that it may be processed only once. Consequently, only one transferable copy per DVD may be made available to the customer as part of the digital library service. This is significant, because the license fee for the transferable copy is significantly less than the normal price to download the digital content through the service because an existing retail version has been verified.

After permanently marking the DVD in the step 204, the method proceeds to a step 205 in which the agent reads an unique content identifier associated with the content stored on the DVD by, for example, scanning the DVD jewel case or DVD cover using a bar code scanner (one example of the content ID reader 104 of FIG. 1) to read the International Standard Book Number (“ISBN”) or reading the media using a media reader (another example of the content ID reader or 104) to read an International Standard Audiovisual Number (“ISAN”), both of which uniquely identifies the digital content on the DVD. The unique content identifier (e.g., ISBN or ISAN) is then transmitted to a remote communication device such as the remote device 102 (which may be a Blackberry® or a notebook computer) through a Bluetooth or hardwired connection.

In a step 206, the unique content identifier for the current DVD is entered into a spreadsheet created on the remote communication device by the agent. In the step 207, the agent determines whether the current DVD is the last DVD to be processed. If it is, then in the step 209, the agent transmits customer information such as the customer's name and contact information along with the spreadsheet including the unique content identifier data for the customer's DVD library to the service provider server 101. The transmission of this information may be performed either over a phone line or through the Internet 150 using a conventional public/private key or other encryption technique. On the other hand, if it is determined by the agent in the step 207 that another DVD is to be processed, then the method jumps back to the step 203 and the agent selects another DVD from the customer's DVD library for processing through the steps 202-209, as described above.

FIG. 3 illustrates a flow diagram of a method performed by the service provider server 101 of FIG. 1 for processing the spreadsheet of unique content identifier data generated and transmitted as described in reference to FIG. 2. In a step 301, the service provider server 101 receives the customer information and unique content identifier data spreadsheet from the remote communication device 102, and in a step 302, an operator or an application program running on the server 101 sets up a customer account using the provided customer information, if one hasn't already been set up for the customer.

In a step 303, a first unique content identifier entry in the spreadsheet is read and in a step 304, a determination is made by the application program running on the server 101 whether the first unique content identifier identifies a digital content that has already been licensed for distribution by the digital content library service. If the determination in the step 304 is NO, then the method proceeds to a step 305 where the unique content identifier is added to a not available list. Then in a step 306, the next unique content identifier entry is read from the spreadsheet and the method jumps back to the step 304 to determine whether the next unique content identifier is licensed.

If the determination in the step 304 is YES, however, then in a step 307, the unique content identifier is added to the customer's available list, which represents all items in the customer's DVD library which are licensed by the library service so that a copy of the digital content may be made available to the customer (either directly or through the retailer) for transfer. After adding the unique content identifier to the customer's licensed list, a determination is then made by the application program whether the unique content identifier is the last unique content identifier entry in the spreadsheet. If it is, then in a step 309, the account set up process for the customer is ended. If the determination in a step 308 is NO, on the other hand, then the method jumps to the step 306 to read the next unique content identifier entry in the spreadsheet and then to loop through the steps 304-308 until the last ISBN entry in the spreadsheet has been processed.

After the customer's account has been established and the customer's available and not available list of unique content identifiers are generated, the customer may log-on the service provider's website and see titles of the digital content on his available and not available lists. Typically, this may be done within a short time after the service provider's agent has transmitted the unique content identifier spreadsheet to the service provider server 101 so that the agent may step the customer through the website while he or she is still with the customer so that the agent can show the customer that most, if not all, of the titles are available now to be provided in the library service. The agent also explains that while some of the titles may not be available now, when they are, the customer will be notified of that when the customer logs-on to the service provider's website. In addition, the agent shows the customer that some of his digital content, such as movies that were originally in standard definition, are now also available for delivery in an updated format, such as high definition, for an additional fee.

Meanwhile back at the retailer's establishment, an employee of the retailer retrieves a digital media player from the retailer's inventory, such as the consumer media player 131, and connects the player to the retailer's fulfillment server 122 via a Universal Serial Bus (“USB”) connection or any other suitable manner. The fulfillment server 122 stores copies of digital content that it has previously downloaded from the service provider's media server 103. The employee then sends a fulfillment token onto the media player, and soon thereafter, copies of the digital content corresponding to unique content identifiers on the customer's available list are bound and delivered to the digital media player from the fulfillment server 122.

The next day, an employee or contractor of the retailer installs the digital media player 131 along with a wireless internet router (if the customer doesn't already have one) at the customer's home. The media player 131 is then plugged into the customer's television or flat panel display through its video and audio inputs, and is connected to the Internet 150 through the router which is connected to the customer's Internet Service Provider (“ISP”) through a modem. The customer may then immediately enjoy his or her digital content library using the media player 131. Over time, as digital content corresponding to unique content identifier entries on the customer's not available list become available, the customer will be notified after logging-on the service provider's website using the media player 131 and television so that the customer can securely download a copy of the content to the hard disk drive of the media player 131.

FIG. 4 illustrates, as an example, a user webpage 400 that is displayed on the customer's television after the user has logged-on to the service through the media player 131. Each user in a family may have a different user identification and password to log-on to the service in much the same way that different users may log-on to a shared personal computer. Also, like the shared personal computer, one of the users may be designated the system administrator and other users may be given limited rights such as the right to purchase content or the right to view certain content (e.g., using built-in parental guidance controls). For example, the system administrator may take advantage of metadata provided by the library service to set rules for every other user, for example, a child user may be prevented from seeing movies above PG-13, or from seeing movies in which a certain actor performs, or from seeing movies of a certain genre. To simplify the following description, the user in this example is assumed to have full rights with respect to the customer's digital content library.

The user webpage 400 shows the titles available for viewing from the customer's digital content library along with their status and information of any available updates through the service. In this example, the digital content includes the listed movies under the “Title” column. All listed movies in this example are standard formatted movies. The movies Amelie and Batman are available for viewing by clicking on their respective PLAY buttons 401 and 402 (e.g., they are on the customer's available list and copies of these movies have been transferred to the media player 131). The movie Soap is unavailable for viewing through the service at this time (e.g., it is still on the customer's not available list). The movie Crash, on the other hand, is available for transfer by clicking on the DOWNLOAD button 403 (e.g., it used to be on the customer's not available list, but now it is on the customer's available list). Adjacent the DOWNLOAD button 403 is a specified fee of $0.99 which the customer agrees to pay by clicking on the DOWNLOAD button 403. After transferring the movie Crash, the movie will be available for viewing and the DOWNLOAD button 403 will change to a PLAY button.

As indicated in the “Available Updates” column (i.e., updates available through the service provider), High Definition (“HD”) formatted versions of the movies Amelie and Crash are available for transfer by clicking on their respective HD buttons 404, 405. Adjacent to each of the buttons 404, 405 is a specified fee which the customer agrees to pay by clicking on the button. In this example, the fee for the HD version of Amelie is $1.99 and the fee for the HD version of Crash is $2.49. Note that the HD version of Crash is more expensive than Amelie, because a copy of the standard formatted version of Amelie has already been downloaded and paid for. The customer is encouraged to upgrade directly to the HD version of Crash, however, because the $2.49 price is less than the combined fee of $2.98 which is what it would cost to first download the standard formatted version of Crash (e.g., $0.99) and then upgrade that version to the HD formatted version (e.g., $1.99).

Also as indicated in the “Available Updates” column, a sequel to the movie Batman is available for purchase or rental. In this case, clicking on the SEQUEL button 406 causes another webpage 500 to be displayed on the customer's television. As shown in FIG. 5, the webpage 500 has a description section 501 that provides information about the sequel, Batman Returns, and three clickable buttons 502, 503, 504. Clicking the TRAILER button 502 plays a trailer of the movie Batman Returns. Clicking the PURCHASE button 503 downloads a copy of the movie to the hard disk of the media player 131, adds the movie to the customer's available content list, and adds the movie to the Title column of the user's webpage 400 along with an adjacent PLAY button in the Status column. Clicking on the PAY-PER-VIEW button 504 streams the movie to media player 131 for viewing on the customer's television. Adjacent the PURCHASE and PAY-PER-VIEW buttons 503, 504 are specified fees which the customer agrees to pay by clicking on their respective buttons.

Referring back to FIG. 4, the user's webpage 400 also has a Search area 407 in which the user can enter conventional keyword search queries to search for movies. To facilitate the search, standard metadata, such as the Title of the movie and the Names of its starring actors, are provided along with each movie downloaded to the media player 131 from the service provider server 101. In addition to being able to search the consumer's digital content library, the search may also include other movies available from the service provider. When a movie listed in the search results is not in the consumer's library, then clicking on the title of that movie causes a webpage, such as the webpage 500, to be displayed on the television screen so that the user is provided a description of the movie and clickable buttons to see a free trailer, purchase the movie for a specified fee, or rent the movie for another specified fee (i.e., view the movie on a pay-per-view basis), as described in reference to webpage 500 of FIG. 5. As previously explained, parental controls using metadata provided by library service may be configured in the media player 131 by the system administrator to restrict what individual users may search for, purchase and/or view.

As mentioned in reference to 305 of FIG. 3, when the digital content on a DVD in the customer's DVD library is not available for downloading from the service provider, because the service provider does not yet have license rights from the content provider to do so, its unique content identifier is placed in a not available list and the user's webpage 400 indicates such unavailability by the designation UNAVAILABLE in the Status column.

Meanwhile, the service provider makes continuing efforts to obtain licensing rights for the not available content to perform its digital content library service. If the content provider is unfamiliar with the library service, an employee of the service provider explains that a primary part of its service is to provide copies of digital content already in the lawful possession of its customers in their respective DVD (or other tangible media) libraries to a hard disk of a digital media player associated with the service so that the customers may easily store, access, and play the digital content on a television (or other display screen) connected to the digital media player while the digital media player ensures that the content is not further copied or otherwise transferred or made available to another device. A fee is charged for each copy transferred to a customer and the transferred copies are referred to as the customer's digital content library. A second part of the service allows customers to stream content included in their digital content libraries to portable media players so that they may enjoy their library “on the go” as well as at home. A monthly subscription is charged for this part of the service. A third part of the service is to offer customers downloadable updates (e.g., updated formats) and sequels to digital content in their library at standard distribution prices. A fourth part of the service is a conventional content distribution function wherein content not currently in the customer's digital content library are made available for downloading and inclusion in the customer's library by purchase or for one-time viewing on a pay-per-view basis. The fees for this part of the service would also be at standard pricing. In exchange for licensing rights to include their digital content in the service, content providers receive shares of the fees charged for the various parts of the service.

If the content provider is not willing to license its digital content to the library service provider at the current time, then the employee leaves the unique content identifier entry in the customer's non-licensed list. On the other hand, if the content provider agrees to license the current unique content identifier's digital content to the library service provider, then a license agreement is executed with the content provider for the content (as well as any other digital content that the content provider is willing to include in the license agreement) and a master copy of the unique content identifier's digital content is downloaded or otherwise obtained from the content provider's server 141 and stored in the service provider's media server 103 (along with standard metadata associated with the content). The unique content identifier entry for the now licensed digital content is then removed from the customer's not available list and added to the customer's available list of digital content. The new entry to the customer's available list is then indicated on the user's webpage with a DOWNLOAD button such button 403 of FIG. 4.

FIG. 6 illustrates, as an example, a flow diagram of a method performed by the service provider server 101 of FIG. 1 for processing a customer's retail purchase as part of the digital content library service. In a step 601, the server 101 receives information for new DVD purchases from a retailer computer such as retailer computer 121 of FIG. 1. In a step 602, a determination is made whether the customer identified in the received information already has a customer account. If the determination in the step 602 is YES, then the method proceeds directly to the step 604. On the other hand, if the determination in the step 602 is NO, then the method proceeds to a step 603 where a customer account is set up for the customer before proceeding to the step 604.

In the step 604, a unique content identifier entry scanned in by the retailer using a bar code scanner for the ISBN or otherwise read from the purchased copy of the digital content itself for the ISAN is read for the first DVD purchased. In a step 605, a determination is made whether the digital content corresponding to the unique content identifier has been licensed by the library service provider from its content provider to perform the various parts of the digital content library service. If the content has not been licensed yet, then in a step 606 the unique content identifier is added to the customer's not available list and the method proceeds to a step 608. On the other hand, if the content corresponding to the unique content identifier has been licensed from its content provider, then in the step 607 the unique content identifier is added to the customer's available list before the method proceeds to the step 608.

In the step 608, a determination is made whether the current unique content identifier entry is the last unique content identifier entry in the received DVD purchase information. If the determination is NO, then in a step 609, the next unique content identifier entry is read and the method jumps back to the step 605 to loop through the steps 605-609 for the next unique content identifier entry. If the determination in the step 608 is YES, however, then the method terminates in a step 610 because it has completed processing information for all newly purchased DVDs. The new entries to the available and not available lists are then handled in the same fashion as the prior entered items in those lists as described in reference to FIGS. 3-5 above.

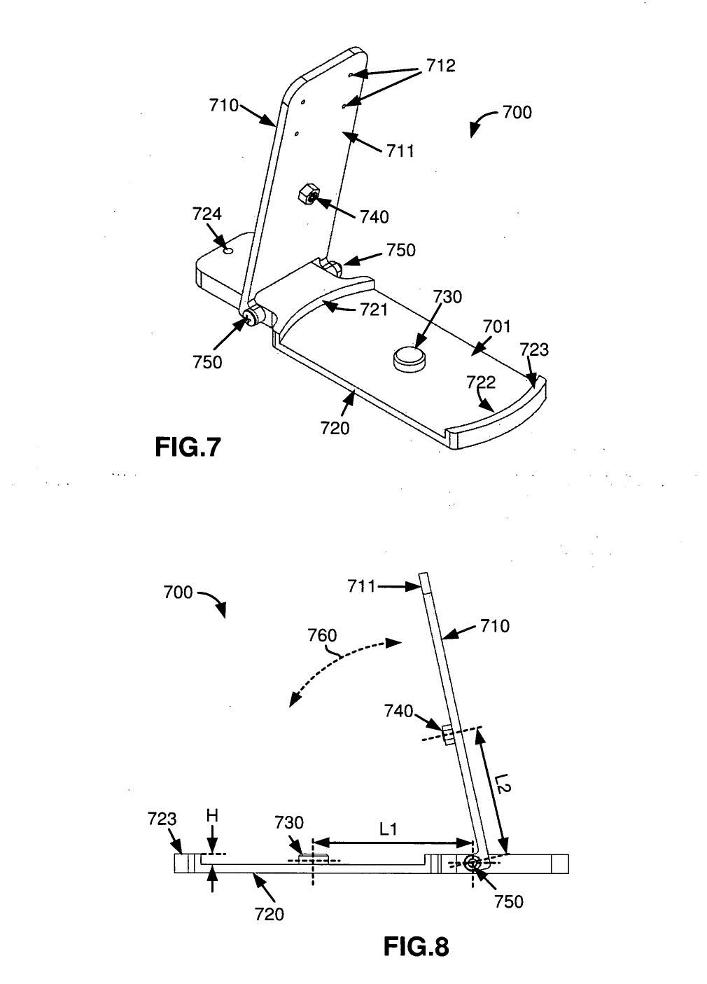

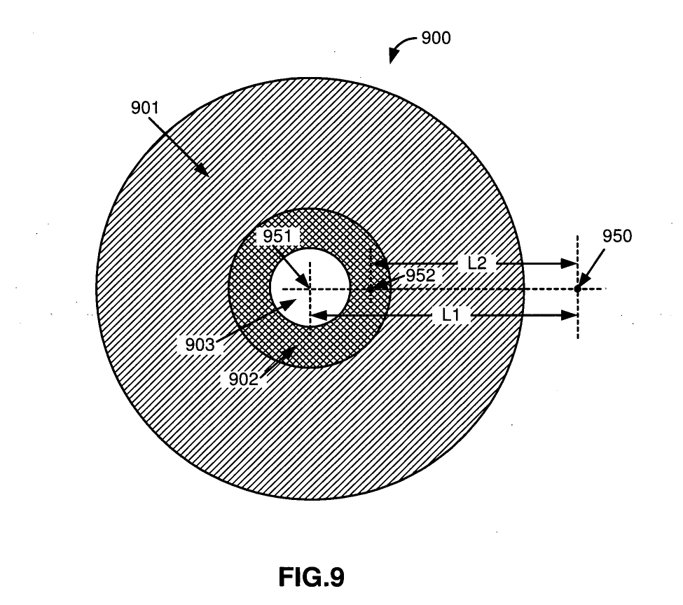

FIGS. 7-8 respectively illustrate, as examples, perspective and side views of a device 700 for marking optical discs (e.g., audio CDs or DVDs) in a nondestructive, tamper-proof manner for licensing and other purposes such as described in reference to the step 204 of FIG. 2. The device 700 has a bottom or base structure 720 for holding optical discs one-at-a-time, a top or lid structure 710 having perforations 711 and a removable tool 740 usable for marking the held optical disc, and a hinge 750 which pivotally couples the top structure 710 to the base structure 720.

FIG. 9 illustrates, as an example, a bottom view of an optical disc 900 having a playable area 901, non-playable area 902, and a central hole 903. The playable area 901 is the area of the optical disc 900 that is read by a disc player's laser pickup assembly for retrieving content stored thereon. In contrast, the non-playable area 902 is not read by the disc player's laser pickup assembly since it does not store content. On the top surface of the optical disc 900, a label identifying the contents of the optical disc 900 may be provided that either covers the entire top surface or just a part opposite the non-playable area 902.

Referring back to FIGS. 7-8, the base structure 720 has a recessed area 701 bounded on two sides by opposing ledges 721, 722. The base structure 720 also has a chamfered mounting post 730 centrally located between the ledges 721, 722 and within the recessed area 701. The opposing ledges 721, 722 are shaped so as to have approximately the same curvature as the optical disc 900. The post 730 is cylindrical in shape having a diameter approximately the same as that of the central hole 903 of the optical disc 900. In addition, the post 730 is chamfered so that the optical disc 900 fits snugly on the mounting post 730 without wobble. At a rear end of the base structure 720 is an attachment hole 724 or other suitable means to facilitate attachment of the marking device 700 on a service technician's tool belt.

The removable tool 740 (also referred to as a “marker”) may be a hexagonal fixing that can be quickly screwed in and out of a threaded receptacle of the top structure 710. The service technician may carry multiple such tools on his or her tool belt, each with its own unique symbol embossed on it. Each symbol may have a different meaning such as to identify different rights, licensing terms and retailers. Accordingly, an optical disc may be marked more than once using different symbols, such as one mark to indicate the licensing terms to be associated with the optical disc and a second mark to indicate the retailer from which the optical disc or such licensing terms have been purchased. Also, different optical discs may be marked with different symbols so as to indicate different rights to be associated with the different optical discs.

The top structure 710 may be manually pivoted about the hinge 750 by a technician so as to move towards or away from the bottom structure 710 as shown by arrows 760. To install (and remove) the tool 740, the top structure 710 is pivoted away from the bottom structure 710 to an open position. To mark an optical disc 900 held in the bottom structure 720, the top structure 710 is pivoted towards the bottom structure 710 to a closed position where the technician applies pressure to the top structure 710 until a bottom surface 711 of the top structure 710 makes physical contact with a top surface 723 of the ledge 722. At this point, the geometries of the marker device 700 result in impressing (or “scoring”) a copy of the tool's symbol (referred to herein as the “mark”) at a point 952 in the non-playable area 902 when sufficient pressure is applied by the technician on the top structure 710.

To ensure proper positioning of the mark on the optical disc 900, the marking device 700 is constructed so that the distance L2 from the hinge 750 to the marker 740 results in the mark being place at the desired position 952 in the non-playable area 902. In particular, where the distance L1 between the hinge 750 and a center of the post 730 in FIG. 8 corresponds to the distance L1 from a point 950 (corresponding to the location of a central axis of the hinge 750) to a point 951 at the center of the hole 903 in FIG. 9, the distance L2 between the hinge 750 and the tool 740 in FIG. 8 should be designed so that the distance L2 from the point 950 results in the mark being placed at the desired position 952 in the non-playable area 902 as shown in FIG. 9.

A typical mark impressed on the optical disc 900 may be approximately 7 millimeters wide and 0.5 millimeters deep. Such dimensions result in a mark that is clearly visible to the naked eye and difficult to remove without damaging the optical disc. However, any other dimensions achieving these objects are also usable to the extent practical with the marking device 700. The desired dimensions of the mark may be achieved by proper design of the tool 740 including the length, width and height of its embossed symbol. The depth (H) of the recessed area 701 is also a consideration and preferably this depth is approximately the thickness of the optical disc 900.

As an alternative to using the removable tool 740, ink injected through one or more of the perforations 712 may be used to mark an optical disc 900 being held at the time in the bottom structure 720. In the present example, the perforations 712 are disposed on the top structure 710 so that a mark resulting from their pattern is placed on the playing area 901 of the optical disc 900. In this case, the ink being used to place the mark is preferably sufficiently semi-transparent to permit a laser to focus through it so that the content thereon may be read. Alternatively, the perforations may be disposed proximate to or in lieu of the marker 740 so that their resulting mark is placed in the non-playing area 902 of the optical disc 900. In either case, preferably the ink will be permanent, indelible and made of a material which is soluble in the same organic solvents that would dissolve the polycarbonate (or other material) of the optical disc 900, so to remove the mark, it would result in melting the polycarbonate layer and destroying the optical disc 900. It is also noted that where multiple perforations are provided such as shown in FIG. 7, several patterns of inked dots may be formed (e.g., injecting ink through different combinations of the four perforations) with each pattern of inked dots indicating a different symbol with a different meaning, such as to identify different rights, licensing terms and retailers.

The marking device 700 is preferably not much longer in length than the diameter of the optical disc 900. As one example, the length may be approximately 150 millimeters. The width and weight of the marking device 700 are preferably minimized so that marking device 700 is lightweight (e.g., approximately 250 grams), portable and easily carried without being cumbersome on the service technician's tool belt. With its simple construction and easy operation, marking of optical discs may be performed quickly in the field (or other location) in seconds with accurate registration of the marks for repeatability and without damage to their playing surfaces.

Although the various aspects of the present invention have been described with respect to a preferred embodiment, it will be understood that the invention is entitled to full protection within the full scope of the appended claims.

What is claimed is:

1. An apparatus for marking an optical disc, comprising:
a first structure;
a second structure having a marker; and
a hinge coupling the first structure to the second structure so that the marker is adapted to mark an optical disc when the optical disc is being held by the first structure and the second structure is pivoted towards the first structure.

2. The apparatus according to claim 1, wherein the first structure includes a post for mounting the optical disc when the optical disc is being held by the first structure.

3. The apparatus according to claim 2, wherein the first structure has a recessed area adapted to hold the optical disc when the optical disc is mounted on the post.

4. The apparatus according to claim 3, wherein the recessed area has opposing curved ledges defining a circle centered at the post and having a diameter large enough to hold the optical disc when the optical disc is mounted on the post.

5. The apparatus according to claim 1, wherein the first structure is adapted at one end to be attachable to a tool belt.

6. The apparatus according to claim 1, wherein the marker is removably attached to the second structure.

7. The apparatus according to claim 1, wherein the marker is adapted to mark an optical disc in an area between an inner diameter and a lead-in of the optical disc when the optical disc is being held by the first structure and the second structure is pivoted towards the first structure.

8. The apparatus according to claim 1, wherein the marker is adapted to make an impression on the optical disc when the optical disc is being held by the first structure and the second structure is pivoted towards the first structure and the marker is pressed against the optical disc.

9. The apparatus according to claim 8, wherein the impression is a symbol impressed into a surface of the area to a depth of at least 0.5 millimeters.

10. The apparatus according to claim 1, wherein the marker is adapted to mark the optical disc with a permanent ink that is not removable without damaging the optical disc when the optical disc is being held by the first structure and the second structure is pivoted towards the first structure and the marker is pressed against the optical disc.

11. A method for marking an optical disc comprising: marking an optical disc by pivoting a marker about a hinge so as to press the marker against an area between an inner radius and a lead-in on a playing surface of the optical disc.

12. The method according to claim 11, further comprising: inserting the optical disc into a recessed area of a first structure so that the optical disc is held by the first structure while the optical disc is being marked.

13. The method according to claim 11, further comprising: mounting the optical disc on a post of a first structure so that the optical disc is held by the first structure while the optical disc is being marked.

14. The method according to claim 11, wherein the pivoting the marker comprises pivoting a second structure having the marker about a hinge that couples the second structure to a first structure holding the optical disc.

15. The method according to claim 14, further comprising: coupling the marker onto the second structure.

16. The method according to claim 11, wherein the pressing of the marker against the area of the optical disc comprises forming an impression in the area.

17. The method according to claim 15, wherein the pressing of the marker against the area of the optical disc comprises marking the area with a symbol in permanent ink that is not removable without damaging the optical disc.

18. A method for marking an optical disc, comprising:
selecting a first marker having a first symbol from a plurality of markers having different symbols;
coupling the first marker to a top structure;
inserting a first optical disc into a recessed area of a base structure and mounting the first optical disc onto a chamfered post of the base structure so that the first optical disc is held by the base structure; and
pivoting the top structure about a hinge coupling the top structure to the base structure so as to impress the first symbol onto the first optical disc in a manner that is not removable without damaging the first optical disc and does not interfere with the playing of content stored on the first optical disc.

19. The method according to claim 18, further comprising:
pivoting the top structure about the hinge so as to move the top structure away from the base structure;
selecting a second marker having a second symbol from the plurality of markers having different symbols;
coupling the second marker to the top structure;
inserting a second optical disc into the recessed area of the base structure and mounting the second optical disc onto the chamfered post of the base structure so that the second optical disc is held by the base structure; and
pivoting the top structure about the hinge so as to impress the second symbol onto the second optical disc in a manner that is not removable without damaging the second optical disc and does not interfere with the playing of content stored on the second optical disc.

20. The method according to claim 18, further comprising:
pivoting the top structure about the hinge so as to move the top structure away from the base structure;
selecting a second marker having a second symbol from the plurality of markers having different symbols;
coupling the second marker to the top structure; and
pivoting the top structure about the hinge so as to impress the second symbol onto the first optical disc in a manner that is not removable without damaging the first optical disc and does not interfere with the playing of content stored on the first optical disc.
